(19) United States
(12) Patent Application Publication
(10) Pub. No.: US 2008/0165173 A1
(43) Pub. Date: Jul. 10, 2008

(54) Display device, controlling method thereof and driving device for display panel

(75) Inventors: Kil-soo Choi, Gyeonggi-do (KR); Kyung-ho Hwang, Gyeonggi-do (KR); Jong-seok Chae, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/006,359

(22) Filed: Dec. 31, 2007

(30) Foreign Application Priority Data
Jan. 9, 2007 (KR) 10-2007-0002607

(51) Int. Cl. G09G 5/00

(52) U.S. Cl. 345/211; 345/1.1

(57) ABSTRACT

A display device, includes: a main display panel; a main driving unit which comprises a driving voltage generating unit that generates a plurality of driving voltages to be supplied for the main display panel and a first driving voltage terminal that outputs the driving voltages, and drives the main display panel; a sub-display panel; a sub-driving unit which comprises a source power terminal that receives source power from the main driving unit, a second driving voltage generating unit, a second driving voltage terminal that is connected with first driving voltage terminal and a switching unit that switches the source power supplied from the source power terminal to the second driving voltage generating unit, and drives the sub-display panel; and a controller which controls the switching unit not to supply the source power from the source power terminal to the second driving voltage generating unit if the main display panel is in a standby mode in which an image is not displayed on the main display panel.

### CROSS-REFERENCE TO RELATED APPLICATIONS

This application claims the benefit of priority of Korean Patent Application No. 10-2007-0002607, filed on Jan. 9, 2007, in the Korean Intellectual Property Office, which is hereby incorporated by reference for all purposes as if fully set forth herein.

### BACKGROUND OF THE INVENTION

1. Field of the Invention

The present invention relates to a display device, a method of controlling a display device and a driving device for a display panel.

2. Description of the Related Art

Recently, display devices such as a liquid crystal display (LCD) device or an organic light emitting diode (OLED) display device have been widely used. Such display devices utilize a display panel including a plurality of pixels.

A folder type portable terminal device may have two display panels and an advertising display device may have multiple display panels. These devices include a plurality of panel driving parts to drive the plurality of display panels and a stabilizing circuit for stabilizing the driving power. Each panel driving unit independently generates driving voltages for a corresponding display panel.

Recently, a power share mode has been used that shares driving power generated by one of a plurality of panel driving parts in order to decrease power consumption. The need to achieve a decrease in power consumption has become a major concern in the field of portable terminal devices.

### SUMMARY OF THE INVENTION

The present invention provides a display device, a method of controlling a display panel and a driving unit for a display panel, all providing a decrease in power consumption.

The foregoing and other aspects of the present invention can be achieved by providing a display device, comprising: a main display panel; a main driving unit, for driving the main display panel, the main driving unit comprising a driving voltage generating unit that generates a plurality of first driving voltages to be supplied to the main display panel and a first driving voltage terminal that outputs the first driving voltages; a sub-display panel; a sub-driving unit, for driving the sub-display panel, the sub-driving unit comprising a second driving voltage generating unit for generating a plurality of second driving voltages, a source power terminal for receiving source power, a second driving voltage terminal that outputs the second driving voltages and a switching unit that switches the source power supplied from the source power terminal to the second driving voltage generating unit; and a controller coupled to the switching unit, wherein the controller instructs the switching unit to switch off the source power to the second driving voltage generating unit if the main display panel is in a standby mode in which an image is not displayed on the main display panel.

According to an aspect of the invention, the first driving voltage terminal comprises a first gate on voltage terminal, a first gate off voltage terminal, a first primitive gray scale voltage terminal to form a gray scale voltage and a first bias voltage terminal of the primitive gray scale voltage.

According to an aspect of the invention, the second driving power terminal comprises a second gate on voltage terminal, a second gate off voltage terminal, a second primitive gray scale voltage terminal and a second bias voltage terminal.

According to an aspect of the invention, when the display device is in standby mode the first gate on voltage terminal, the second gate on voltage terminal, the first bias voltage terminal and the second bias voltage terminal are connected to ground.

According to an aspect of the invention, when the display device is in an external power mode, the source power terminal receives source power from the main driving unit, the first driving voltage terminal is connected to the second driving voltage terminal so that the first gate on voltage terminal is connected to the second gate on voltage terminal, the first gate off voltage terminal is connected to the second gate off voltage terminal, the first primitive gray scale voltage terminal is connected to the second primitive gray scale voltage terminal and the first bias voltage terminal is connected to the second bias voltage terminal.

According to an aspect of the invention, the second driving voltage generating unit comprises an amplifier which comprises a switch device.

According to an aspect of the invention, the amplifier is plurally provided if the second driving power terminal is plurally provided, and the plurality of amplifiers are connected in series.

According to an aspect of the invention, the switching unit comprises a source power input terminal for receiving the source power, a source power output terminal for outputting the source power to the second driving voltage generating unit, a first switch connected between the source power input terminal and the source power output terminal, a second switch and a regulator, the second switch and the regulator being connected in series between the source power input terminal and the source power output terminal.

According to an aspect of the invention the first switch is open and the second switch is open in the standby mode.

According to an aspect of the invention, the source power input terminal receives source power from the main driving unit, the first switch is closed and the second switch is open in an external power mode in which an image is displayed on the main display panel.

According to an aspect of the invention, in an internal power mode, the source power terminal receives source power from a source other than the main driving unit, the first switch is open and the second switch is closed so that the source power is regulated by the regulator.

According to an aspect of the invention, the switching unit comprises a metal-oxide semiconductor (MOS) device.

The foregoing and other aspects of the present invention can be achieved by providing a driving device for a display panel, comprising: a source power terminal for receiving source power from an outside source; a driving voltage terminal for outputting driving voltages that drive the display panel; an amplifier which comprises a switch device, amplifies the source power received from the source power terminal to generate a driving voltage, and outputs the driving voltage to the driving voltage terminal; and a switching unit which cuts off the source power when the display panel is in a standby mode in which an image is not displayed on the display panel.

According to an aspect of the invention, the driving voltage terminal is connected to ground in the standby mode.

According to an aspect of the invention, the switching unit comprises a source power input terminal for receiving the source power, a source power output terminal for outputting the source power to a terminal of the amplifier, a first switch connected between the source power input terminal and the source power output terminal, a second switch and a regulator, the second switch being connected in series with the regulator between the source power input terminal and the source power output terminal.

According to an aspect of the invention, the first switch and the second switch are turned off, i.e. open in the standby mode.

According to an aspect of the invention, the first switch is turned on, i.e. closed and the second switch is turned off, i.e. open in an external power mode in which an image is displayed on the main display panel.

The foregoing and other aspects of the present invention can be achieved by providing a method of controlling a display device, which comprises a main driving unit that drives a main display device and a sub-driving unit that drives a sub-display panel, the sub-driving unit comprising a source power terminal for receiving source power, a driving voltage generating unit for generating a plurality of driving voltages, and a driving voltage terminal for outputting the plurality of driving voltages, comprising: selecting an external power mode that provides a driving voltage from the main driving unit to the sub-driving unit; and cutting off the source power provided to the driving voltage generating unit from the source power terminal if the main driving unit is set to a standby mode in which an image is not displayed.

According to an aspect of the invention, the driving voltage terminal is connected to ground if the main driving unit is set to the standby mode.

According to an aspect of the invention, the controlling method of the display device in which the source power terminal is supplied with the source power from the main driving unit in the external power mode.

### BRIEF DESCRIPTION OF THE DRAWINGS

These and other aspects of the present invention will become apparent and more readily appreciated from the following description of the embodiments, taken in conjunction with the accompanying drawings, in which:

FIG. 1 is a schematic drawing of a display device according to an exemplary embodiment of the present invention;

FIG. 2 is a block diagram of the display device according to the exemplary embodiment of the present invention;

FIG. 3 is a circuit diagram of a driving unit according to the exemplary embodiment of the present invention;

FIG. 4 is a circuit diagram of a switch in a switching unit portion of the driving unit according to the exemplary embodiment of the present invention; and

FIG. 5 is a control flow chart of a method of controlling the display device according to the exemplary embodiment of the present invention.

### DETAILED DESCRIPTION OF THE PREFERRED EMBODIMENTS

Reference will now be made in detail to the embodiments of the present general invention, examples of which are illustrated in the accompanying drawings. The same elements are given the same reference numerals in various embodiments, and they will be typically described in a first embodiment of the present general inventive concept, and may be omitted in other embodiments of the present general invention.

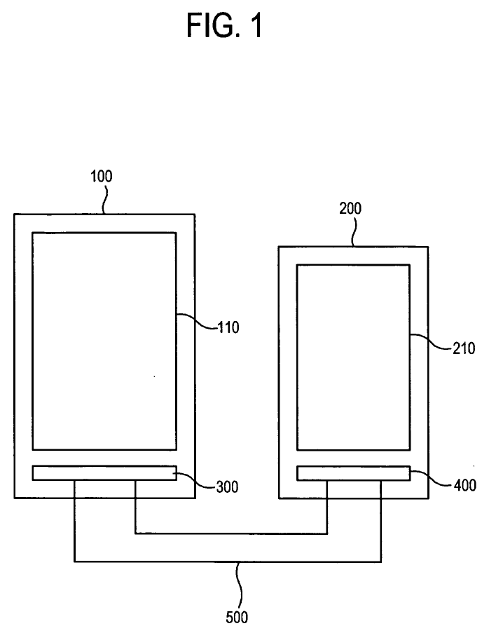

FIG. 1 is a schematic drawing of a display device according to an embodiment of the present invention.

As shown in FIG. 1, the display device according to the embodiment of the present invention has a dual panel structure including a main display panel 100 and a sub-display panel 200. Such a dual panel structure may be used in a folder type portable phone. FIG. 1 may also represent a display device having multiple display panels for displaying advertisements. The display device includes a main driving unit 300 that drives the main display panel 100 and a sub-driving unit 400 that drives the sub-display panel 200.

The main display panel 100 and the sub-display panel 200 may include a liquid crystal panel that includes a liquid crystal layer, or an organic light emitting diode (OLED) device that includes an organic light emitting layer, and they have a display region 110 and a display region 210, respectively, on which images are displayed. The display regions 110 and 210 include a plurality of pixels, the pixels being arranged in a row and column matrix (not shown). Each pixel generally includes red, green and blue sub-pixels, and each sub-pixel includes a switching device such as a thin film transistor. Gate lines to supply gate on/off signals to the thin film transistors, and data lines to supply data signals corresponding to image signals to the thin film transistors, are formed on the display regions 110 and 210. Images are displayed on the display regions 110 and 210 by various control signals that are output from the driving unit 300 and sub-driving unit 400, respectively.

Chips containing the main driving unit 300 and the sub-driving unit 400 are mounted on the display panels 100 and 200, respectively, by using chip on glass technology. As the display device used for the portable terminal tends to be designed slimmer and smaller, one chip in which all circuit units generating driving signals are integrated is generally used.

The main driving unit 300 and the sub-driving unit 400 according to another exemplary embodiment are not mounted on the display panels 100 and 200 in chip form but may be formed through the same process that forms the thin film transistors. That is, the driving unit 300 and the sub-driving unit 400 may include a shift register including a plurality of thin film transistors.

The main driving unit 300 and the sub-driving unit 400 each include a driving voltage generating unit that generates various driving voltages necessary to display images on the display panels 100 and 200. A timing controller that receives and processes image signals from an outside source controls the driving voltage generating unit and outputs various control signals. The driving voltages generated by the driving voltage generating unit include, a gate on voltage and a gate off voltage that are supplied to the gate lines, a primitive gray scale voltage to express a plurality of gray scales, a bias voltage of the primitive gray scale voltage to generate the primitive gray scale voltage, and a common voltage.

The display device also includes a stabilizing circuit board (not shown) provided with a plurality of capacitors to stabilize the driving voltages generated in the driving units 300 and 400.

The sub-driving unit 400 is conventionally driven in an internal power mode wherein the sub-driving unit 400 receives source power from a source other than the main driving unit 300, generates driving voltages and drives the sub display panel 200.

The sub-driving unit 400 according to the present exemplary embodiment can also operate in an external power mode, wherein the source power and a part of the driving power are received by the sub-driving unit 400 from the main driving unit 300, to decrease power consumption. The external power mode has another merit, that of sharing a stabilizing circuit.

The source power and the part of the driving power received by the sub-driving unit is transmitted from the main driving unit 300 to the sub-driving unit 400 through a flexible film 500 that connects the two driving units 300 and 400. The flexible film 500 includes a flexible plastic material formed with a conductive metallic pattern therein.

The display device according to the present exemplary embodiment uses the sub-driving unit 400 which can be used in either the internal power mode or the external power mode. However, the power consumption is decreased by adopting the external power mode. If the flexible film 500 is removed while the display device is in the external power mode, the internal power mode may be selected again.

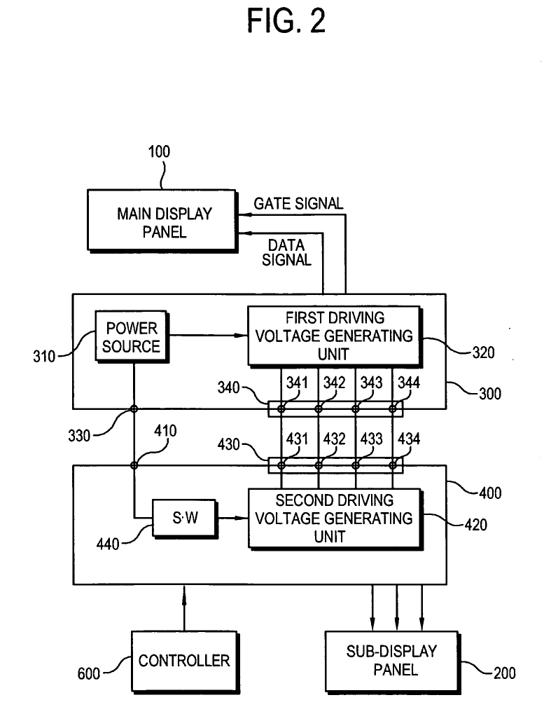

FIG. 2 is a block diagram of the display device according to the exemplary embodiment of the present invention. As shown in FIG. 2, the main driving unit 300 includes a power source 310, a first driving voltage generating unit 320 that generates the various driving voltages using the source power supplied from the power source 310, and provides the various driving voltages to a first driving voltage terminal 340. The first driving voltage terminal 340 is connected to a second driving voltage terminal 430 of the sub-driving unit 400. Though not shown, the main driving unit 300 may comprise another driving voltage terminal that is not connected to the second driving voltage terminal 430, and that outputs driving voltages that are directly supplied to the main display panel 100 or used to generate other voltages. Also, the main driving unit 300 includes a first source power terminal 330 and the sub-driving unit includes a second source power terminal 410.

In the internal power mode, the first source power terminal 330 and the second source power terminal 410 are not connected with each other, and the first driving voltage terminal 340 and the second driving voltage terminal 430 are not connected with each other.

In the external power mode, the second source power terminal 410 is connected to the first source power terminal 330 and receives the source power from the main driving unit 300. The second driving voltage terminal 430 is connected with the first driving power terminal 340. In the external power mode, the driving voltages provided to the sub-driving unit 400, from among the driving powers generated by the first driving voltage generating unit 320, include the gate on voltage, the gate off voltage, the primitive gray scale voltage to form a plurality of gray scale voltages and the bias voltage of the primitive gray scale voltage. Accordingly, the first driving voltage terminal 340 and second driving voltage terminal 430 include gate on terminals 341 and 431, gate off terminals 342 and 432, primitive gray scale voltage terminals 343 and 433, and bias voltage terminals of the primitive gray scale voltage 344 and 434.

A second driving voltage generating unit 420 is connected with the second driving voltage terminal 430. Since the sub-driving unit 400 according to the present exemplary embodiment is not specially manufactured to be used in the external power mode but is on a chip that is intended to be used in the internal power mode, the sub-driving unit 400 still includes the second driving voltage generating unit 420 to generate driving voltages, of course, the second driving voltage generating unit 420 generates the driving voltage other than the driving voltage received from the main driving unit 300.

A switching unit 440 is provided between the second source power terminal 410 and the second driving voltage generating unit 420. The switching unit controls the transmission of the source power supplied from the second source power terminal 410 to the second driving voltage generating unit 420.

A controller 600 controls the switching unit 440. In the standby mode, in which an image is not displayed on the main display panel, the controller 600 directs the switching unit 440 not to supply the power from the second source power terminal 410 to the second driving voltage generating unit 420. The controller 600, if it receives a control signal for the standby mode, outputs a control signal to control the switching unit 440. Though the controller 600 in FIG. 2 is shown outside of the sub driving unit 400, FIG. 2 is not meant to limit a position of the controller 600, but the controller 600 may be included in the main driving unit 300 or the sub-driving unit 400, or may be provided externally in a separate way.

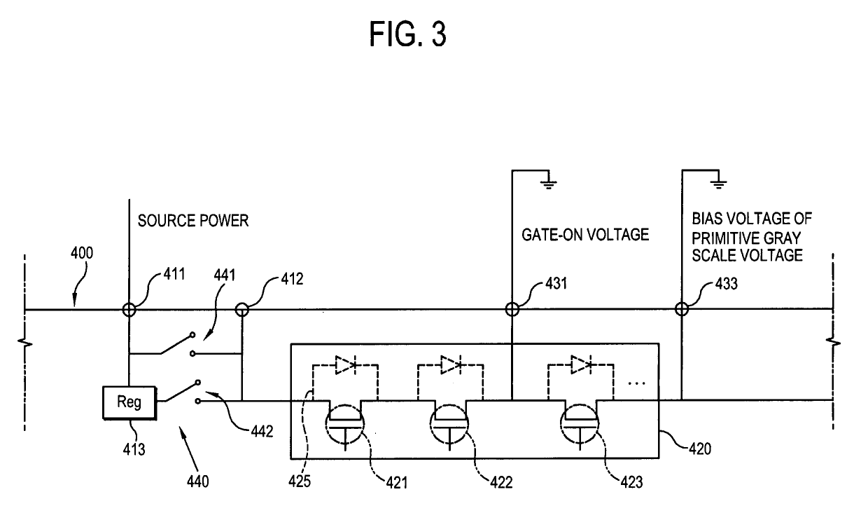

FIG. 3 is a circuit diagram of a driving device according to the exemplary embodiment of the present invention. The driving device according to the present exemplary embodiment drives the sub-display panel 200 and receives a predetermined driving power from the outside. The driving device of FIG. 3 includes the sub-driving unit 400 of FIG. 2. The driving device is explained hereinafter with the sub-driving unit 400 as an example.

The switching unit 440 includes a source power input terminal 411 and a source power output terminal 412. A first switch 441 connects the source power input terminal 411 to the source power output terminal 412. The source power input terminal 411 is also connected through a regulator 13 in series with a second switch 442 to the source power output terminal 412. The source power input terminal 411 may be supplied with source power from one of two sources. In the external power mode, the source power input terminal 411 receives the source power from the first source power terminal 330 of the main driving unit 300 via the second source power terminal 410. In this mode the first switch 441 is closed and the second switch 442 is open so that the source power is supplied to the second voltage generating unit 420 via the source power output terminal 412. In the internal power mode, the source power input terminal 411 receives the source power from a source (not shown) that is separate from the main driving unit 300. In this mode the first switch 441 is open and the second switch 442 is closed so that the source power passes through the regulator 413 to the second driving voltage generating unit 420 via the source power output terminal 412.

In the external power mode, since the source power supplied from the main driving unit 300 is regulated source power, the regulator 413 is bypassed. In this case, the source power input terminal 411 and the source power output terminal 412 have the same electrical potential.

The second driving voltage generating unit 420 may include a plurality of amplifiers that amplify the source power and provide the driving voltages to the second driving voltage terminal 430, and each amplifier includes a plurality of switch devices 421, 422 and 423 and other circuit devices. The switch devices 421, 422 and 423 switch the power according to a predetermined control signal, and the source power is amplified by an operation of the switch devices 421, 422 and 423 to provide output voltages to the terminals on the second driving voltage terminal 430. The amplifiers are connected in series, and accordingly, the switch devices 421, 422 and 423 are connected in series from the source power output terminal 412. The switch devices 421, 422 and 423 may include metal-oxide semiconductor (MOS) transistors, and are turned off if generation of the driving voltages is unnecessary. However, even if the switch devices 421, 422 and 423 are turned off, a parasitic diode 425 is naturally formed in the switch devices 421, 422 and 423 connected in series.

When the standby mode, in which an image is not displayed on the main display panel 100, is selected while the display device is in the external power mode sharing the power with the main driving unit 300, the gate on terminal 341 of the first driving voltage terminal 340 and the bias voltage terminal 343 of the primitive gray scale voltage are generally connected to ground to prevent image-sticking. If the main display panel 100 is set in the standby mode, the sub-display panel 200 sharing the power with the main display panel 100 is also set in the standby mode. Also, the gate on voltage terminal 431 of the second driving voltage terminal 430 that is connected with the main driving unit 300 and the bias voltage terminal 434 of the gray scale voltage are connected to ground to reduce voltage levels.

Conventionally, a voltage difference between the gate on voltage terminal 431 and the bias voltage terminal of the second driving voltage terminal 430 and the parasitic diode 425 of the switch devices 421, 422 and 423 caused a problem of producing an unnecessary current in the standby mode. This situation goes against the purpose of the external power mode which is to reduce the power consumption. To improve this situation, the sub driving unit 400 according to the present exemplary embodiment includes the switching unit 440 to cut off a supply of the source power to the second driving voltage generating unit 420 while in the standby mode.

The switching unit 440 includes the source power input terminal 411, the source power output terminal 412 and the first switch 441 provided between the source power input terminal 411 and the source power output terminal 412. The switching unit 440 also includes the second switch 442 and the regulator 413 provided between and the source power input terminal 411 and the source power output terminal 412.

In the standby mode, both the first switch 441 and the second switch 442 are turned off i.e. open as shown in FIG. 3 and accordingly source power is not provided to the output terminal 412. In other words, the current does not flow to the parasitic diode 425 because the source power is not transmitted to the source power output terminal 412. The detected currents at the source power terminal 410 were approximately between 3.2 mA and 3.55 mA before the driving device was provided with the switching unit 440, but the current is remarkably reduced to between 17 μA and 21 μA by preventing the current flow with the switching unit 440 following the present exemplary embodiment.

In normal operation in the external power mode, an image is displayed, the first switch 441 is turned on, i.e. closed, and the second switch 442 is turned off, i.e. open. The source power input terminal 411 and the source power output terminal 412 are connected by the first switch 441. The source power received from the first source power terminal 330 appears at the source power output terminal 412. The source power from the source power output terminal 412 is used to generate the driving voltages other than the driving voltages supplied from the main driving unit 300.

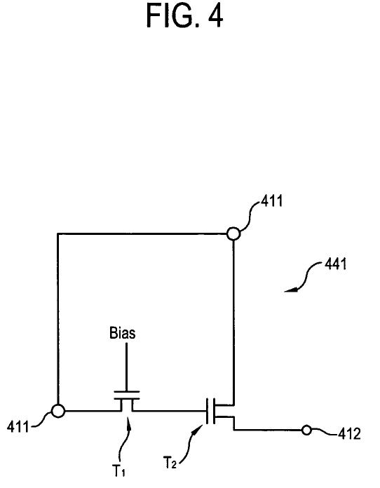

FIG. 4 is a circuit diagram of one of the switches in switching unit 440 according to the exemplary embodiment of the present invention. In the switching unit 440 N-channel MOS (NMOS) transistors may be used in the first switch 441 and in the second switch 442. The first switch 441 is described as an example of both switches. The first switch 441 includes a first transistor T1 and a second transistor T2. An input terminal of the first transistor T1 and an input terminal of the second transistor T2 are connected to each other and to the source power input terminal 411. Also, an output terminal of the first transistor T1 is connected to a control terminal of the second transistor T2, and an output terminal of the second transistor T2 is connected with the source power output terminal 412. A bias voltage is applied to a control terminal of the first transistor T1.

In normal operation in the external power mode, the bias voltage is applied on the control terminal of the first transistor T1. Thus the first transistor T1 and the second transistor T2 are turned on consecutively and the source power is transmitted to the output terminal of the second transistor T2 of the switch 441.

If now the control signal for the standby mode is inputted, the bias voltage ceases to be applied on the control terminal of the first transistor T1 in order to turn off, or open, the first switch 441. Then, the first transistor T1 and the second transistor T2 are turned off consecutively, and no power is outputted through the output terminal of the second transistor T2.

The configuration of the switching unit 440 is not limited to the one with the NMOS mentioned above but may include various known circuit components.

If, the sub driving unit 400 is driven in the internal power mode, the first switch 441 is open, i.e. off, and the second switch 442 is closed, i.e. on, in the normal operation that displays the image. In other words, the inputted source power to the second driving voltage generating unit 420 is regulated by the regulator 413.

If, while in the internal power mode, the system is taken out of normal operation and put into standby, the first switch 441 remains open, i.e. off, and the second switch 442 is opened, i.e. turned off, to prevent current flow to the parasitic diode 425.

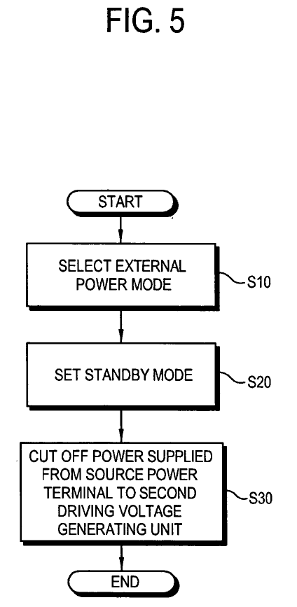

FIG. 5 is a control flow chart to explain a control method for the display device according to the exemplary embodiment of the present invention. Referring to FIG. 5, a control method for the display device is summarized as follows.

First, the external power mode, in which a predetermined driving power generated from the main driving unit 300 is supplied to the sub-driving unit 400 S10, is selected.

For the external power mode, the first source power terminal 330 and the second source power terminal 410 are connected and the first driving voltage terminal 340 and the second driving voltage terminal 430 are connected using the flexible film 500.

If the standby mode, wherein an image is not displayed, is set in the main driving unit 300 S20, then the first driving voltage terminal 340 is connected to ground, the second driving voltage terminal 430 also is connected to ground. At this time, in order to prevent current flow through the parasitic diode 425, the source power from the second source power terminal 410 to the second driving voltage generating unit 420 is cut-off S30. More precisely, the source power to the amplifiers, which are a part of the second driving power generating unit 420 provided between the second source power terminal 410 and the second driving voltage terminal 430, is cut-off. As a result, the current flow through the parasitic diode 425 is remarkably reduced and the power consumption is also reduced.

As mentioned above, the present invention provides a display device, a driving unit for a display panel and a controlling method thereof to decrease power consumption.

It will be apparent to those skilled in the art that various modifications and variations can be made in the present invention without departing from the spirit or scope of the invention. Thus it is intended that the present invention cover the modifications and variations of this invention provided they come within the scope of the appended claims and their equivalents.

What is claimed is:

1. A display device, comprising:
a main display panel;
a main driving unit for driving the main display panel, the main driving unit comprising a first driving voltage generating unit operative to generate a plurality of first driving voltages to be supplied to the main display panel and a first driving voltage terminal that outputs the first driving voltages;
a sub display-panel;
a sub-driving unit for driving the sub display panel, the sub driving unit comprising a second driving voltage generating unit for generating a plurality of second driving voltages, a source power terminal for receiving source power, a second driving voltage terminal that outputs the second driving voltages, and a switching unit adapted to switch the source power supplied from the source power terminal to the second driving voltage generating unit; and
a controller coupled to the switching unit, the controller being operative to instruct the switching unit to switch off the source power to the second driving power generating unit if the main display panel is in a standby mode in which an image is not displayed on the main display panel.

2. The display device according to claim 1, wherein the first driving voltage terminal comprises a first gate on voltage terminal, a first gate off voltage terminal, a first primitive gray scale voltage terminal to form a gray scale voltage and a first bias voltage terminal of the primitive gray scale voltage.

3. The display device according to claim 2, wherein the second driving voltage terminal comprises a second gate on voltage terminal, a second gate off voltage terminal, a second primitive gray scale voltage terminal and a second bias voltage terminal.

4. The display device according to claim 3, wherein, if the display device is in standby mode, the first gate on voltage terminal, the second gate on voltage terminal, the first bias voltage terminal, and the second bias voltage are connected to ground.

5. The display device of claim 2, wherein, in an external power mode, the source power terminal receives source power from the main driving unit, the first driving voltage terminal is connected to the second driving voltage terminal with the first gate on voltage terminal connected to the second gate on voltage terminal, the first gate off voltage terminal connected to the second voltage off voltage terminal, the first primitive gray scale voltage terminal is connected to the second primitive gray scale voltage terminal and the first bias voltage terminal connected to the second bias voltage terminal, so that the first driving voltages outputted by the first driving voltage terminal are supplied to the second driving voltage terminal.

6. The display device according to claim 1, wherein the second driving voltage generating unit comprises an amplifier which comprises a switch device.

7. The display device according to claim 1, wherein the switching unit comprises a source power input terminal for receiving the source power, a source power output terminal for outputting the source power to the second driving voltage generating unit, a first switch connected between the source power input terminal and the source power output terminal, a second switch and a regulator, the regulator being connected is series with the second switch between the source power input terminal and the source power output terminal.

8. The display device according to claim 7, wherein, in the standby mode, the first switch is open and the second switch is open.

9. The display device according to claim 7, wherein, the source power input terminal receives source power from the main driving unit, the first switch is closed and the second switch is open in an external power mode in which an image is displayed on the main display panel.

10. The display device according to claim 7, wherein, in an internal power mode, the source power input terminal receives source power from a source other than the main driving unit, the first switch is open and the second switch is closed so that the source power is regulated by the regulator.

11. The display device according to claim 1, wherein the switching unit comprises a metal-oxide semiconductor (MOS) device.

12. A driving device for a display panel, comprising:
a source power terminal for receiving source power from an outside source;
a driving voltage terminal for outputting driving voltages that drive the display panel;
an amplifier which comprises a switch device, amplifies the source power received from the source power terminal to generate a driving voltage, and outputs the driving voltage to the driving voltage terminal; and
a switching unit which cuts off the source power if the display panel is in a standby mode in which an image is not displayed on the display panel.

13. The driving device for the display panel according to claim 12, wherein the driving voltage terminal is connected to ground in the standby mode.

14. The driving device for the display panel according to claim 12, wherein the switching unit comprises a source power input terminal for receiving the source power, a source power output terminal for outputting the source power to a terminal of the amplifier, a first switch connected between the source power input terminal and the source power output terminal, a second switch and a regulator, the second switch being connected in series with the regulator between the source power input terminal and the source power output terminal.

15. The driving unit for the display panel according to claim 14, wherein, the first switch and the second switch are open in the standby mode.

16. The driving unit for the display panel according to claim 14, wherein the first switch is closed and the second switch is open in an external power mode in which an image is displayed on the main display panel.

17. A controlling method of a display device, which comprises a main driving unit that drives a main display panel and a sub-driving unit that drives a sub-display panel, the sub-driving unit comprising a source power terminal for receiving source power, a driving voltage generating unit for generating a plurality of driving voltages and a driving voltage terminal for outputting the plurality of driving voltages, comprising:
selecting an external power mode that provides a driving voltage from the main driving unit to the sub-driving unit; and
cutting off the source power provided to the driving voltage generating unit from the source power terminal if the main driving unit is set to a standby mode in which an image is not displayed.

18. The controlling method of the display device according to claim 17, wherein the driving voltage terminal is connected to ground if the main driving unit is set to the standby mode.

19. The controlling method of the display device according to claim 17, wherein the source power terminal is supplied with the source power from the main driving unit in the external power mode.
